(19) United States
(12) Patent Application Publication
(10) Pub. No.: US 2007/0279316 A1
(43) Pub. Date: Dec. 6, 2007

(54) Optical Display System for a Vehicle

(75) Inventors: Rainer Daude, Unterschleissheim (DE); Guenter Metsch, Moeglingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/580,860

(22) PCT Filed: Oct. 29, 2004
(86) PCT No.: PCT/EP04/12288

§ 371 Date: Jun. 20, 2007

(30) Foreign Application Priority Data
Nov. 27, 2003 (DE) 103 55 462.9

(51) Int. Cl. G09G 5/00

(52) U.S. Cl. 345/2.1

(57) ABSTRACT

An optical display system for a vehicle (10), having at least one first display unit (1) and at least one second display unit (2), with information for display being allocated to the at least one first display unit (1) and/or to the at least one second display unit (2). It is possible to switch from the at least one first display unit (1) to the at least one second display unit (2), or from the at least one second display unit (2) to the at least one first display unit (1), as a function of a determined current driving situation, in order to display the information.

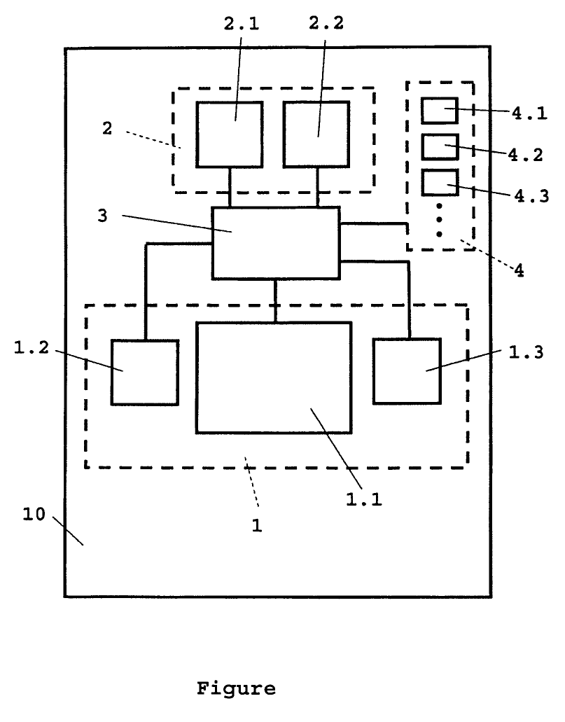

### BACKGROUND AND SUMMARY OF THE INVENTION

The invention relates to an optical display system for a vehicle.

Modern vehicles have a plurality of display units for displaying information comprising vehicle or appliance parameters, which is made available by vehicle subsystems such as a vehicle traction system and/or convenience systems such as a navigation system, a multimedia control system etc., and/or by safety systems such as an antilock braking system, a lane changing system etc. The information displayed on the various display units varies continuously, for example as a function of the current driving states of the vehicle or of control actions by the user. This can lead to the driver either not receiving information at the appropriate time or being distracted for an unreasonably long time from his primary driving task and from the observation of the surrounding traffic situation, if this information is displayed on the “wrong” display unit. Furthermore, the information display is subject to legal requirements in some countries.

German Patent Document DE 101 51 282 A1 discloses an optical display system for a vehicle, in which the amount of information displayed can be varied by means of a control element.

German Patent Document DE 100 56 302 A1 discloses an optical display system for a vehicle having a central display unit and an additional display unit. In the case of the described optical display system, the information which is displayed on one of the two display units can be transferred to the other of the two display units by means of a switching process which is carried out manually by the user. The switching process is initiated by the user by operation of a multifunction control element or of a transfer key. The manual switching process can be used to transfer a limited amount of control and information from the central display unit to the additional display unit. Alternatively or additionally, the manual switching process can be used to transfer an extended amount of control and information from the additional display unit to the central display unit. The manual switching process can be used, for example, to display information from a navigation system both on the central display unit and on the additional display unit.

The object of the invention is to specify an improved optical display system for a vehicle having at least two display units, by means of which legal requirements are complied with and the driver distraction is reduced.

The invention is based on the idea that the displayed information can be switched automatically from at least one first display unit to at least one second display unit, or from the at least one second display unit to the at least one first display unit, as a function of a determined current driving situation. This makes it possible to provide an information display matched to the driving situation.

In a further embodiment of the invention, the first display unit is used to display information from a first vehicle subsystem during normal operation of the vehicle, with this first display unit being arranged, for example, outside the central field of view of the driver, with a change being made to display the information from the first vehicle subsystem on the second display unit in a particular driving situation, for example a hazard situation, with this second display unit being arranged, for example, within the central field of view of the driver. In this case, the first display unit may be arranged in the area of the center console of the vehicle or above this center console on the dashboard, in the area of the front-seat passenger or in the rear-seat area. Display units, such as displays on the combination instrument or head-up displays which are arranged in the area of the steering wheel or are projected onto the windshield above the steering wheel, are located in the central field of view of the driver.

In order to further reduce driver distraction, in one advantageous development of the invention, after switching from the first display unit to the second display unit, the corresponding information is masked out on the first display unit, and after switching from the second display unit to the first display unit, the corresponding information is masked out on the second display unit. Furthermore, the described embodiments of the invention guide the driver's attention to the most important information in the respective situation.

In another refinement of the invention, the current driving situation is determined by an evaluation and control unit as a function of data from at least one vehicle subsystem.

In one advantageous refinement of the invention, the information from at least one first vehicle subsystem is allocated to be displayed on the at least one first display unit, which is arranged outside the central field of view of the driver, in which case it is possible to switch to the at least one second display unit in order to display the information when the first driving situation is determined, which second display unit is arranged in the central field of view of the driver.

The information which can be displayed from the at least one vehicle subsystem comprises, for example, a hazard warning, in which case the first driving situation is determined by the evaluation and control unit when a hazard situation occurs.

In a further embodiment, a vehicle subsystem is in the form of a navigation system. The information which can be displayed from the navigation system comprises, for example, complicated navigation information. In order to display the complicated navigation information on the second display unit, the evaluation and control unit switches the information output from the navigation system from the first display unit to the second display unit when a first driving situation is determined in the form of a complicated navigation maneuver.

Furthermore, the information which can be displayed from the navigation system comprises information for inputting destinations in the navigation system. When the vehicle is stationary, this information is displayed on the first display unit, for example in the form of character strings. During driving operation, this display can excessively distract the driver from his primary driving task, so that the evaluation and control unit switches from the first display unit to the second display unit for the information output when a first driving situation is determined in the form of driving operation being identified, with a list of possible destinations being displayed for selection, for example.

In a further refinement, information from at least one second vehicle subsystem can be allocated to the at least one first display unit for display, with the information additionally being allocated to the at least one second display unit when a second driving situation is determined.

The second driving situation is determined by the evaluation and control unit when, for example, the vehicle is stationary.

The at least one second vehicle subsystem is, for example, in the form of a television or video system or an interface to the Internet, with the information from the second vehicle subsystem comprising, for example, moving images. In order to avoid excessively distracting the driver from his primary driving task, moving images are displayed to him only when stationary, while other vehicle occupants can also view the moving images while driving.

In a further refinement, a display type and/or the scope of the displayed information are/is varied when switching between the display units.

The display type for the information includes, for example, the size and/or color and/or contrast and/or the form of representation.

One advantageous embodiment of the invention is illustrated in the drawing and will be described in the following text.

### BRIEF DESCRIPTION OF THE DRAWINGS

The sole FIGURE shows a block diagram of an optical display system for a vehicle.

### DETAILED DESCRIPTION OF THE DRAWINGS

As can be seen from the single FIGURE, the display system in a vehicle 10 comprises at least one first display unit 1, which is arranged outside the central field of view of the driver and, for example, is in the form of a screen in the center console 1.1 and/or above this center console 1.1 on the dashboard and/or in the front-seat passenger area 1.2 and/or in the rear-seat passenger area 1.3, at least one second display unit 2 which is arranged within the central field of view of the driver and, for example, is in the form of a display area in the combination instrument 2.1 and/or is in the form of a head-up display 2.2, an evaluation and control unit 3, which switches the information display from the at least one first display unit 1 to the at least one second display unit 2, or from the at least one second display unit 2 to the at least one first display unit 1 as a function of a determined current driving situation, with the current driving situation being determined by the evaluation and control unit 3 by evaluation of data from at least one vehicle subsystem 4. In the described exemplary embodiment, by way of example, the at least one vehicle subsystem 4 comprises a vehicle traction system and/or a navigation system and/or a video or television system and/or an interface to the Internet and/or a multimedia control system and/or an antilock braking system and/or a lane changing assistance, etc.

After switching from the first display unit 1 to the second display unit 2, the relevant information is masked out on the first display unit 1, and after switching from the second display unit 2 to the first display unit 1, the information is masked out on the second display unit 2.

In the described exemplary embodiment, when first vehicle subsystems are being operated, the information which can be displayed from these first vehicle subsystems is displayed on the at least one first display unit 1, which is in the form of a screen in the center console 1.1. If the evaluation and control unit 3 determines a first driving situation, then the evaluation and control unit 3 switches the information display to the second display unit 2, which is arranged in the central field of view. This is done, for example, when the evaluation and control unit 3 determines a hazard situation and the aim is to emit a hazard message to the driver from the relevant vehicle subsystem.

If the at least one vehicle subsystem 4 comprises, for example, a navigation system 4.1, then the information from the navigation system 4.1 is allocated to the display on the at least one first display unit 1, for operation and routing purposes. If, for example during routing, the evaluation and control unit 3 determines a complicated navigation maneuver, then the associated complicated navigation information to carry out this complicated navigation maneuver is displayed on the second display unit 2, by switching the display units.

If a speller is used for operating the navigation system 4.1, for example when entering destinations, that is to say an input method where individual characters are selected from a character string that is displayed on the first display unit, then the display system according to the invention ensures that the input method is not used while driving, with the evaluation and control unit switching to a list display for entering destinations on the second display unit 2 when it determines that the vehicle 10 is being driven.

If the at least one vehicle subsystem 4 comprises, for example, a video or television system 4.2 or an interface to the Internet 4.3, then the information from these vehicle subsystems 4.2, 4.3, which may also include moving images, can be displayed on the first and on the second display unit 1, 2 when the evaluation and control unit determines that the vehicle 10 is stationary. When the evaluation and control unit 3 determines that the vehicle 10 is being driven, then the evaluation and control unit 3 blocks the second display unit 2, so that this information is then displayed only on the first display unit 1, which is arranged outside the central field of view of the driver.

When switching between the display units 1, 2, a display type and/or the scope of the displayed information can be varied. For example, when changing the display type, the size and/or the color and/or the contrast and/or the form of representation can be varied, so that the displayed information can be optimally matched to the changed conditions of the newly used display unit.

The optical display system according to the invention allows the information display to be optimally matched to the driving situation by selection of the appropriate display unit for the determined current driving situation, thus reducing the driver distraction and guiding the driver's attention to the information which is most important in the respective situation. Furthermore, the optical display system according to the invention makes it possible to satisfy legal requirements easily, by using the evaluation and control unit to allocate the information to the display units which are stipulated in advance for the display of this information.

1-16. (canceled)

17. An optical display system for a vehicle, comprising:
at least one first display unit and
at least one second display unit,
with information for display being allocated to the at least one first display unit and to the at least one second display unit, wherein
switching from the at least one first display unit to the at least one second display unit, or from the at least one second display unit to the at least one first display unit, occurs as a function of a determined current driving situation, in order to display the information.

18. The optical display system as claimed in claim 17, wherein, after switching from the first display unit to the second display unit, corresponding information is masked out on the first display unit, and after switching from the second display unit to the first display unit, the corresponding information is masked out on the second display unit.

19. The optical display system as claimed in claim 17, further comprising an evaluation and control unit, which determines the current driving situation by evaluation of data from at least one vehicle subsystem.

20. The optical display system as claimed in claim 17,
wherein the at least one first display unit is arranged outside the central field of view of the driver.

21. The optical display system as claimed in claim 17,
wherein the at least one second display unit is arranged within the central field of view of the driver.

22. The optical display system as claimed in claim 17, wherein information from at least one vehicle subsystem is allocated to be displayed on the at least one first display unit, in which case it is possible to switch to the at least one second display unit in order to display the information when a first driving situation is determined.

23. The optical display system as claimed in claim 22, wherein the information which can be displayed from the at least one vehicle subsystem comprises a hazard warning, whereby the first driving situation can be determined by the evaluation and control unit when a hazard situation occurs.

24. The optical display system as claimed in claim 22, wherein the at least one vehicle subsystem comprises a navigation system.

25. The optical display system as claimed in claim 24, wherein the information displayed from the navigation system comprises complicated navigation information, whereby the first driving situation can be determined by the evaluation and control unit when a complicated navigation maneuver occurs.

26. The optical display system as claimed in claim 24, wherein the information which displayed from the navigation system comprises information for inputting destinations in the navigation system, whereby the first driving situation can be determined by the evaluation and control unit during normal driving operation of the vehicle.

27. The optical display system as claimed in claim 16, wherein information from at least one vehicle subsystem is allocated to be displayed on the at least one first display unit, whereby the information when a second driving situation is determined is additionally allocated to the at least one second display unit.

28. The optical display system as claimed in claim 27, wherein the second driving situation is determined by the evaluation and control unit when the vehicle is stationary.

29. The optical display system as claimed in claim 27, wherein the information from the at least one vehicle subsystem comprises moving images.

30. The optical display system as claimed in claim 27, wherein the vehicle subsystem is one of a television and video system, and an interface to the Internet.

31. The optical display system as claimed in claim 17, wherein when switching between the display units, at least one of a display type and the scope of the displayed information can be varied.

32. The optical display system as claimed in claim 31, wherein the display type comprises at least one of the size and color and contrast and the representation.

33. The optical display system as claimed in claim 18, further comprising an evaluation and control unit, which determines the current driving situation by evaluation of data from at least one vehicle subsystem.

34. The optical display system as claimed in claim 18, wherein the at least one first display unit is arranged outside the central field of view of the driver.

35. The optical display system as claimed in claim 18, wherein the at least one second display unit is arranged within the central field of view of the driver.

36. The optical display system as claimed in claim 19, wherein the at least one second display unit is arranged within the central field of view of the driver.
